(19) United States
(12) Patent Application Publication
(10) Pub. No.: US 2010/0017222 A1
(43) Pub. Date: Jan. 21, 2010

(54) Systems and Methods For Scheduling Healthcare Visits

(75) Inventors: Vijaykalyan Yeluri, Sunnyvale, CA (US); Robert Herfkens, Stanford, CA (US); Denny Lau, Emeryville, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/175,923

(22) Filed: Jul. 18, 2008

(51) Int. Cl. G06Q 10/00

(52) U.S. Cl. 705/2

(57) ABSTRACT

Methods and systems are provided for searching for and scheduling healthcare provider visit appointments via a user interface. A user may access a healthcare visit agent via the internet, and instruct the agent, via a user interface, to conduct a search among one or more healthcare provider systems for available visit appointments. In certain embodiments the agent generates an array of available appointments based on search criteria entered by a user via the user interface, and then populates the user interface with the array. A user may then select one or more healthcare provider appointments from the array, and instruct a scheduler to reserve the appointment time for the user at the healthcare provider. In certain embodiments the user may search for available appointments based on visit basis criteria, location criteria, calendar criteria, insurance criteria, patient satisfaction criteria and patient retention criteria.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain embodiments of the present technology relate to scheduling healthcare visits. More particularly, certain embodiments relate to systems and methods for offering healthcare appointment options to a user based on user entered search criteria.

Scheduling a healthcare visit can be a time consuming and laborious task for both patients and healthcare personnel. For example, when a patient intends to schedule an appointment with a healthcare provider, the patient must contact the provider's office and work out a time that fits into both the patient's and the provider's schedule. If the patient is unable to obtain an appointment within a desired time frame, the patient must then locate and contact another provider in the patient's vicinity of travel that practices the type of medicine necessary for the patient's desired treatment and is covered by the patient's medical insurance, for example. The process continues until the patient finds a provider that meets all the patient's requirements and has a convenient appointment time available. This can be inconvenient for a patient, as it can be difficult for a patient to locate and contact multiple providers. It can also be burdensome for the patient to determine the particular type of medicine the provider practices, and the types of insurance that the provider accepts.

Furthermore, there can also be difficulties with scheduling for a provider or hospital. For example, some services, such as physical therapy, respiratory therapy, X-rays and the like may only be able to handle one, or a few patients at a particular time. Additionally, a patient may require multiple treatments and thus require several appointments, possibly at various facilities, but can only be scheduled to be in one place at one time. In order to properly schedule patients, the technicians in the various organizations or institutions, and the nurses or other practitioners on the patient floor must constantly be in communication with the patients by telephone to set up appropriate schedules. This takes up valuable time for the hospital personnel, which otherwise could be used for direct patient care. Further, emergency situations often occur in a hospital, resulting in changes to the schedule to permit the emergency tests to be performed, thereby causing normally scheduled non-emergency tests to either be rescheduled or causing the patient to wait for long periods of time at the service area. Again, this takes up additional time of the hospital support personnel which could be better utilized in providing direct patient care.

There thus exists a demand for a scheduling system that provides a user, such as a potential patient or a healthcare personnel member, a scheduling support tool offering the user with a list of potential practitioners, locations and time slots available based on certain user search criteria. Currently there exists systems, for example, general physician office systems, healthcare information systems (HIS), electronic medical record (EMR) systems and departmental information systems that contain scheduling functionalities, but none of these provide a service for a patient to search across different providers to find the most suitable provider. Identification of providers that participate in a particular health plan may be a feature provided by the health plan, either through coverage manuals or through the health plan website, but these features do not offer a provider comparison to help the patient identify the most suitable provider based on the patients needs and desires. Nor does a health plan offer scheduling functionalities.

Currently travel websites such as Expedia.com, Orbitz.com and Travelocity.com provide travelers a tool that offers a variety of travel options based on certain user search criteria. For example, a user may desire to find flights from one city to another on a given day or days. The user can enter the airports or cities, dates and times for the desired trip as well as other options such as whether the user will require a hotel or automobile, for example. The tools then provide the user with a list of available flights sorted by time of flight, duration of flight or cost of flight, and the user may reserve and purchase flight tickets using the tool. A similar tool offering assistance in scheduling healthcare visits is not presently offered. Thus, there exists a need for a scheduling tool that provides a user with healthcare visit options based on user selection criteria, and that offers a scheduling tool to schedule the desired appointments with the provider.

### BRIEF SUMMARY OF THE INVENTION

Certain embodiments present a method for scheduling a patient appointment to visit a healthcare provider via a user interface. In certain embodiments, the method includes prompting a user for appointment criteria via the user interface. Next, at least one healthcare provider system is searched for available appointments based on the appointment criteria, and an array of available healthcare provider appointments is generated based on the search results. Next, the user interface is populated with the array of available healthcare provider appointments, each of the appointments corresponding to a particular healthcare provider or providers. In certain embodiments a user is then prompted to select one or more appointments from the generated array via the user interface, and the appointment is reserved on the healthcare provider system.

Certain embodiments present a healthcare visit agent for searching for and scheduling healthcare provider appointments for a user. In certain embodiments, the agent includes a user interface allowing the user to interact with the agent via a network. A healthcare network server connects the agent with one or more healthcare systems. In certain embodiments, the appointment search engine is in communication with the user interface and the healthcare network server. In certain embodiments there is also an appointment scheduler in communication with the user interface and the healthcare network server. The user interface prompts a user for search criteria, and the appointment search engine searches for available healthcare provider appointments on the healthcare provider systems via the healthcare network server. The appointment search engine populates the search results on the user interface, and the appointment scheduler reserves appointments on the healthcare provider systems upon receiving appointment instructions from a user via the user interface. In certain embodiments the search criteria may be one or more of visit basis criteria, location criteria, calendar criteria, insurance criteria, patient satisfaction criteria and patient retention criteria.

Certain embodiments present a computer readable medium encoded with instructions for execution in a computer system. The instructions, when executed on a computer system, provide access to a user interface via a computer workstation. In certain embodiments, the instructions offer one or more healthcare provider appointment search criteria for user selection the interface. Upon command from a user via the user interface, the instructions instruct a search engine to conduct a search on at least one healthcare provider system for available healthcare provider appointments based on the user selected healthcare provider appointment search criteria, or criterion. In certain embodiments, the instructions offer one or more healthcare provider appointments to a user via the user interface. Upon a selection of one or more of the healthcare provider appointments by a user, the instructions may instruct a scheduler to reserve the healthcare provider appointment or appointments with the healthcare provider.

### BRIEF DESCRIPTION OF SEVERAL VIEWS OF THE DRAWINGS

FIG. 1 illustrates a system providing access to healthcare appointment scheduling via a user interface.

FIG. 2 illustrates operation of a system for scheduling an appointment in accordance with certain embodiments of the disclosed technology.

FIG. 3 illustrates operation of a search engine in accordance with certain embodiments of the disclosed technology.

FIG. 4 illustrates an exemplary screen shot of a user interface in accordance with an embodiment of the disclosed technology.

FIG. 5 illustrates a flow diagram of a method for scheduling a healthcare visit in accordance with an embodiment of the disclosed technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods for providing a user with healthcare visit options based upon information entered by a user. A “user,” as the term is used herein, may be a patient, a physician or healthcare provider, a clinic, a hospital, an insurance company, or any person or group that desires to schedule a visit for a patient with a healthcare provider. For example, a patient may schedule his or her own healthcare provider appointments, or a healthcare clinic may refer the patient to another clinic and schedule the appointment on the patient's behalf. In certain embodiments, a user may schedule a healthcare visit appointment based on the options presented to the user. A “healthcare provider or a “provider” as the terms are used throughout this description can refer to any person, group or organization that provides healthcare, medical or otherwise, to a patient. For example, a provider may be a hospital, a clinic, a physician or group of physicians, or a healthcare system.

A user desiring to schedule an appointment with a healthcare provider will have needs, requests, and preferences regarding that visit. For example, a patient may wish to see a healthcare provider to treat problems the patient has been having with lower back pain. The patient may not wish to travel beyond a certain distance. For example, if the patient does not have access to an automobile, the user may not wish to visit a provider located more than one mile from the patient's home address. The user may also only wish to visit a provider that is a part of the patient's healthcare or insurance plan. For example, if the patient is provided with Health Maintenance Organization (HMO) healthcare insurance, the patient may only wish to visit providers that are members of the same HMO plan. Additionally, the patient may have requirements or preferences regarding the date and times for the visit. A patient may only wish to be provided with a list of providers that accept appointments on Tuesdays after 5 PM, on weekends, or during the lunch hour for example.

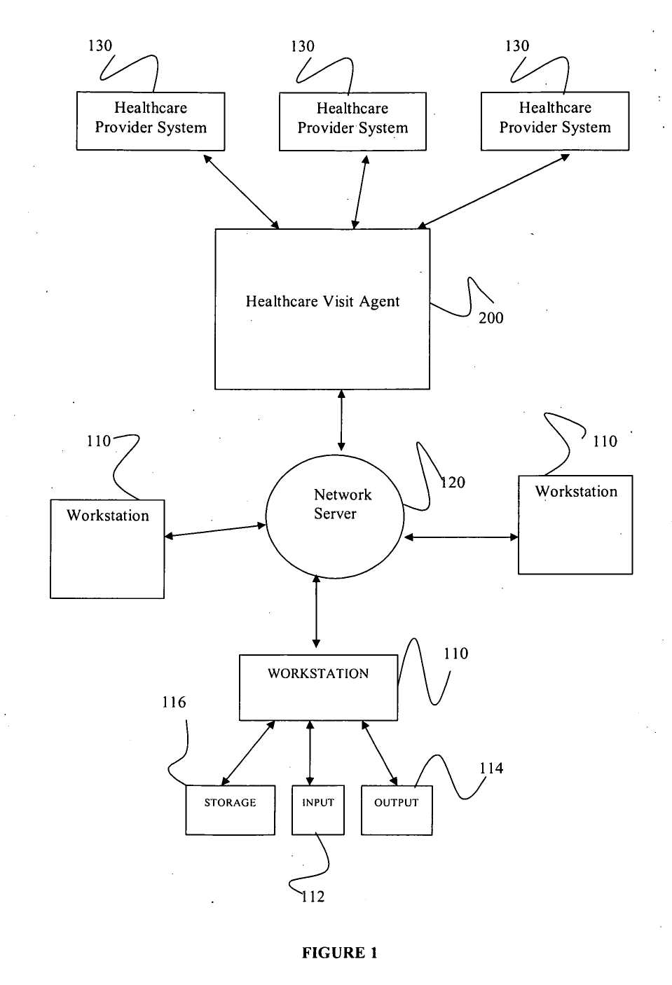

FIG. 1 depicts an embodiment of a networking system 100 for which the present technology may be implemented. The system includes a workstation 110, or a plurality of workstations 110. The workstations 110 may include an input device 112 or devices, such as a keyboard, mouse or any device allowing a workstation user to input data and interact with the workstation 110. The workstations may also include an output device 114 such as a printer or a monitor that provides data and/or information to a user. The workstation may also include a data storage unit 116 such as a hard drive or any memory device allowing the workstation 110 to save and store data and/or information.

The workstation 110, or workstations, are connected to a network server 120 allowing access to external workstations, databases, systems or other stations on the system 100. The network server 120 may be, the internet, for example. A user may therefore interact with other workstations 110 through the user's workstation 110 via the network server 120.

The network server provides workstation 110 access to a healthcare visit agent 200. The healthcare visit agent 200 may be an internet webpage, for example, where the network server 120 is the internet. In certain embodiments, the network server 120 may be a local intranet, and the healthcare visit agent 200 may be a local intranet page.

The healthcare visit agent 200 accesses a healthcare provider system 130, or a plurality of provider systems 130. The provider systems 130 may be a facility system such as a hospital, or a provider's office, for example. In certain embodiments, the provider systems 130 may represent a range of healthcare facilities, for example, a network of hospitals or healthcare providers.

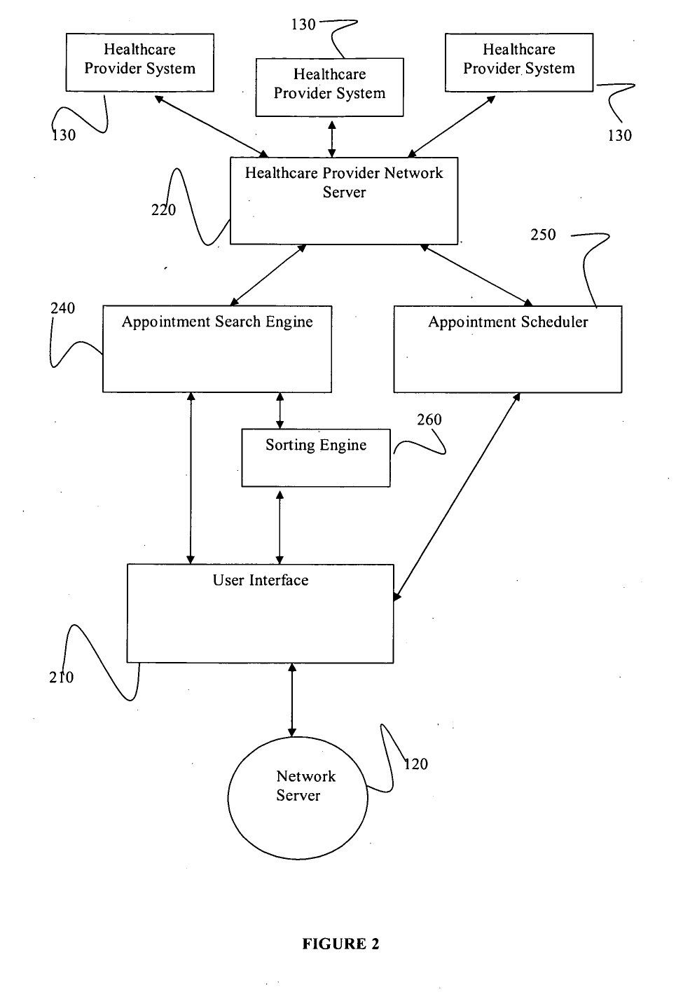

FIG. 2 illustrates the components of the healthcare visit agent 200. A user interface 210 provides a way to allow user interaction with the agent 200 through a network server 120. For example, the user interface 210 may be an internet web page that a user connected to the internet via a workstation 110 may access. In certain embodiments, the user may provide one or more search criteria to the search engine 240 via the user interface 210. The search criteria may be in the form of user preferences pertaining to the user's preferred healthcare visit options. For example, the search criteria may be information pertaining to the preferred geographic region of the healthcare providers.

In certain embodiments, the user interface 210 may request search criteria from the user by providing options in the form of polls, queries, or other requests, for example. In certain embodiments, the user interface 210 may request input from a user by requiring the selection of at least one menu item. For example, the interface 210 may request a user select a date from a list of available appointment dates via a pull-down menu. In certain embodiments the interface 210 may provide a request, or prompt a user to manually enter information, through mouse, keyboard or other workstation commands. For example, the interface 210 may prompt a user for a user preference pertaining to the user's desired geographic region, the user's health insurance provider, or the user's desired provider practice area. The entry may be in the form of selecting a user preference from a list provided preference options, or via a manual entry of a user preference via a keyboard or voice command, or by another input means. For example, a user may enter a user preference search criteria pertaining to geographic region by selecting a geographic region from a map.

In certain embodiments the user may be required to enter certain information. For example, the user interface may require the input of a user's name, address, age, social security number or other personal information. In certain embodiments, the user interface 210 may operate initially without requiring any information pertaining to the user.

In certain embodiments, the user may operate the agent 200 through the user interface 210 by entering only one search criteria. For example, a user may elect only to provide a search criteria pertaining only to the user's desired geographic region. In other embodiments, the user may operate the healthcare visit agent 200 by entering a plurality of search criteria, or user preferences, including, but not limited to, all user preference requests prompted by the interface 210.

The user interface 210 submits the search criteria to an appointment search engine 240. The appointment search engine 240 interacts with one or a plurality of healthcare systems 130 through a healthcare network server 220. In certain embodiments, the healthcare network server 220 may be the same network server as network server 120. For example, the healthcare network server 220 and the network server 120 may be the Internet. In certain embodiments, the healthcare network server 220 is a separate server that is connected only to certain healthcare systems 130.

The healthcare provider systems 130, or system, connected to healthcare network server 220 provide information necessary to schedule patient appointments. For example, the provider systems 130 may be a database containing information to pertaining to patient appointments for providers on the particular provider system 130. In certain embodiments, the healthcare systems provide information to providers practice areas, locations, accepted insurance providers, available and unavailable appointment times, and available medical equipment on site, for example. Certain embodiments may include healthcare systems 130 that provide information pertaining to patient satisfaction with the providers, or the providers patient retention rate.

The appointment search engine 240 obtains search results pertaining to provider appointments from the healthcare network server 220. In certain embodiments the search results may include one, or more than one appointment times. In other embodiments, the results obtained by the search engine 240 includes no appointment times. For example, there may be no appointments available to meet the search criteria where a user enters several limiting criteria over a limited time frame and/or geographic region.

A sorting engine 260 orders the search results based on the search criteria. For example, where the search criteria indicated the user preferred to see the appointment times in terms of soonest availability, the sorting engine 260 will produce the search results on the user interface 210 such that the soonest available appointment times are listed first. In certain embodiments, a user may elect multiple sorting criteria. For example, a user may elect to see first all search results in a particular city, and to see all results from that particular city that are available on a particular date first. In certain embodiments, a user may access the sorting engine 260 via the user interface 210 to modify the sorting order after a search has been completed. For example, the sorting engine 260 may produce a list of appointments where all appointments at a particular clinic are listed first. After viewing the displayed appointments, the user may desire to view all search results having an available appointment time on a particular day by accessing the sorting engine 260 via the user interface 210.

Once presented with the search results via the user interface 210, a user may elect to run another search. For example, if the search results yielded too many search results, the user may wish to re-run the search using stricter search criteria. Alternatively, if the search results yield too few available appointments, the user may wish to expand the search using more broad criteria. For example, the user may elect to expand the scope of the geographic region where the original search yielded no available appointments.

When a user has been presented with an appointment suitable to the user's preference, the user may schedule, or reserve that appointment via the user interface 210. Through commands entered via the user interface 210, the user may instruct an appointment scheduler 250, to reserve the appointment with a healthcare provider. In certain embodiments, the appointment scheduler may interact with a healthcare provider's scheduling system, or healthcare provider system 130, to schedule and/or reserve an appointment. The appointment scheduler 250 interacts with one or more provider scheduling systems 130 through the healthcare provider network server 220 to reserve the appointment time slot for the user, and update the particular provider's system 130 with the appointment information. For example, the appointment scheduler 250 may update the appointment time status from “available” to “unavailable” once a user schedules, or reserves the appointment. Further, the appointment scheduler 250 may provide the particular healthcare provider scheduling system 130 with all the patient information necessary to schedule an appointment. For example, the appointment scheduler may update the provider system 130 with the patient's name, contact information, insurance information, social security information, and medical history. In certain embodiments the appointment scheduler may confirm the appointment with either or both of the patient and the provider. For example, the appointment scheduler 250 may send an email to the patient, notifying the patient of the appointment time and location. In certain embodiments, the appointment scheduler 250 may receive payment information, such as credit card information, to secure the appointment time, pay a deposit, or submit a payment in full.

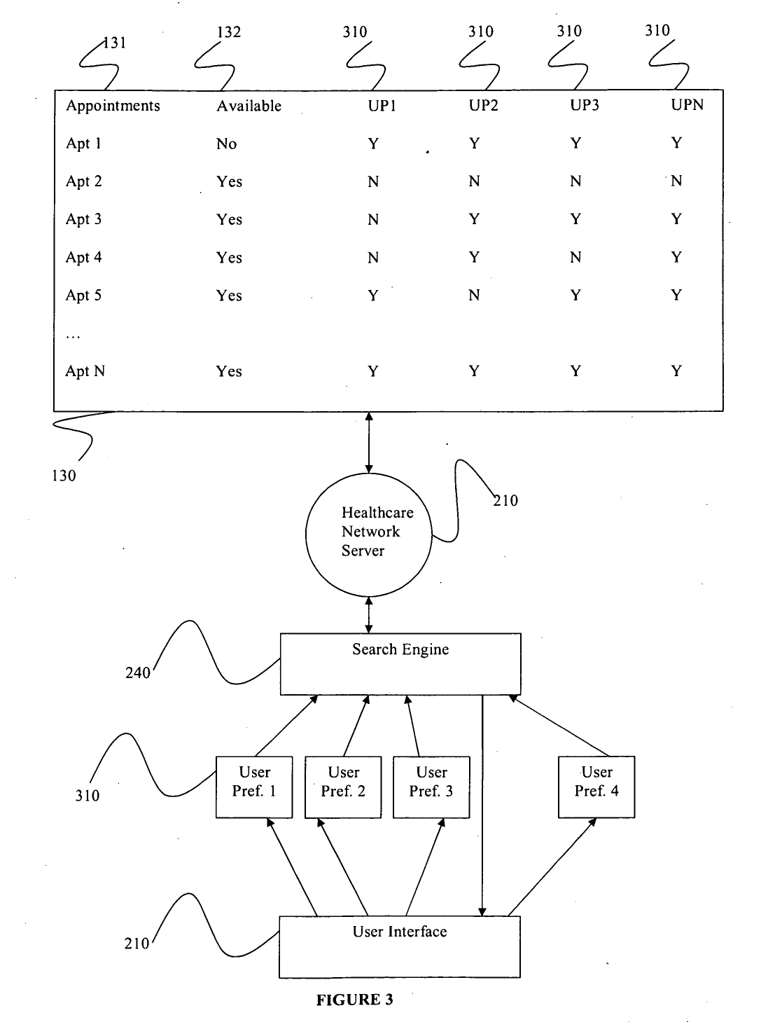

FIG. 3 depicts a schematic diagram of the operation of the search engine 240. The search engine 240 receives search criteria 310 from the user interface. The search criteria may be in the form of a plurality of user preferences, depicted as UP1 (User Pref. 1), UP2, UP3, . . . , UPN, as depicted in FIG. 3, for example. The search engine 240 then connects to the provider systems 130 through the healthcare network server 220. The search engine 240 crawls through the systems and databases on the healthcare provider systems 130 discovering provider appointments 131 that meet the search criteria. In the healthcare provider system 130 of FIG. 3, appointments meeting user preference criteria are depicted with a “Y” in the user preference columns, and preferences not meeting the criteria are depicted with an “N” in the column.

In certain embodiments, the search engine 240 may obtain only appointment times that meet all of the search criteria 310. In other embodiments, the search engine 240 may pull the available appointment times that meet the most search criteria. For example, the search engine 240 may pull the five appointment times that meet the most search criteria 310, even if some criteria 310 are not met for all the appointment times. In the embodiment depicted in FIG. 3, for example, the search engine 240 may pull only Appointment N, as that is the only available appointment that meets all the search criteria, or the search engine 240 may pull the Appointments 5 and 3, as those appointments meet almost all the search criteria. In certain embodiments, the search engine may pull appointments that are not available where search criteria are met. For example, the search engine may pull Appointment 1 as depicted in FIG. 3, so that a user may contact the healthcare provider and request to be placed on a waitlist for the appointment, or to be notified if there is a cancellation.

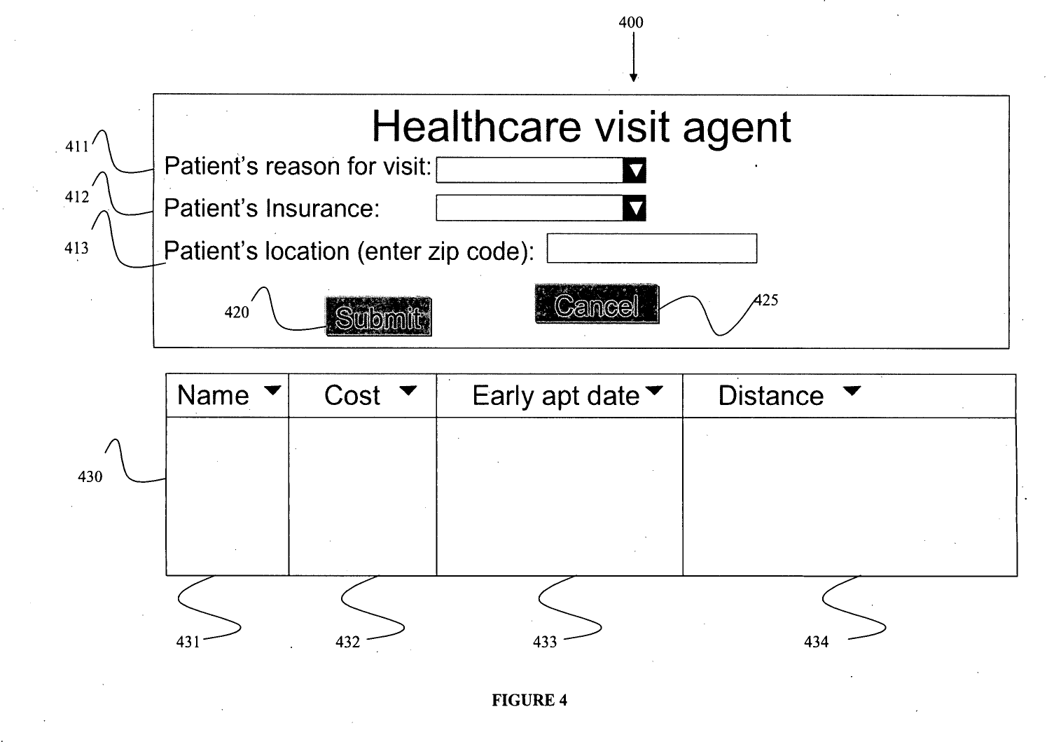

FIG. 4 depicts a screen shot of a user interface 400 in operation with an embodiment of the present technology. A user may enter search criteria through the interface by typing in information, selecting information from a pull-down menu or by other input means. For example, a user may select a reason for a visit 411 from a list of available options in a pull down menu including, but not limited to: general check up; referral; prescription; follow-up visit; and examination, for example. A user can also enter search criteria based on practitioner specialties, such as dental, general physician, optometrist, for example. In certain embodiments, a user may enter search criteria via a tiered structure pull-down menu that uses sub-categories. For example, a user may be able to select first from a practitioner specialty, and then select from a list of patient symptoms (for e.g.; sore throat, eye infection, toothache, etc). In certain embodiments, the interface 400 can prompt a user for information pertaining to the Patient's insurance 412, and patient's location 413, for example. The user may execute the search by clicking on a “submit” button 420. Alternatively, the user may cancel a search, or reset the search criteria by clicking on the “cancel” button. After conducting the search, the results may be populated in area 430, which may include columns for certain information regarding the appointment. For example, the interface 400 may produce a list of providers names in column 431, the anticipated cost of the visit in 432, the earliest date available for the appointment in 433 and the distance from the user's location in 434. In certain embodiments, the interface may display additional information, or omit certain information depending on the search results and the user's search criteria. For example, in certain embodiments the interface may provide a column for other patients' satisfaction ratings for the provider, or the providers' patient retention rates.

In certain embodiments, the user may establish an account with the healthcare visit agent 200. For example, a user may provide a user name with a password such that each time the user logs into the healthcare visit agent 200, the user can pull information pertaining to the user and the user's preferences, saving the user the time from re-entering the information. The agent may use user information to assist the scheduling of appointments with the provider. For example, the agent may maintain a record of the user's insurance information, saving the user the burden of finding and entering the information each time an appointment is scheduled.

In certain embodiments, the agent may maintain a user calendar on the user account. The system may consult with the user calendar when producing the list of available appointments. For example, where an appointment with a physician conflicts with another appointment on the user's calendar, the agent may not offer the appointment to the user, or the interface may produce the appointment with a warning notation, indicating that the appointment is a potential conflict with the user's calendar.

The agent may also receive input from users pertaining to the visit to the provider. For example, the user may enter information pertaining to the user's satisfaction with the provider via the agent 200. Other users may review the user satisfaction ratings of particular providers in determining which providers to schedule their appointment.

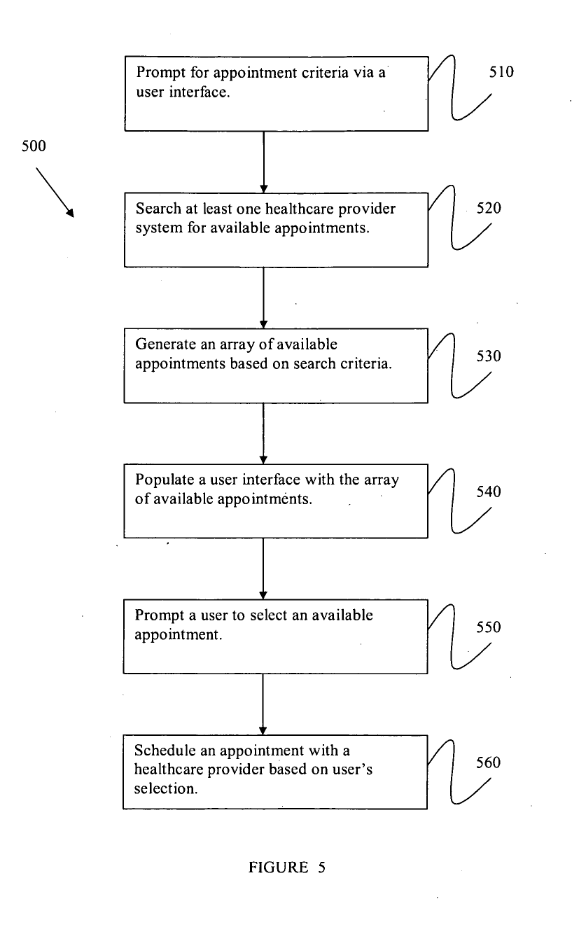

FIG. 5 depicts a flow diagram of one method 500 for scheduling a healthcare provider appointment for a patient in accordance with certain embodiments of the present technology. At step 510 an agent, such as a website, or the agent 200 described herein, prompts a user for appointment criteria via a user interface. For example, the agent may prompt a user for information corresponding to the reason for the user's visit (visit basis criteria), information corresponding to the user's location (location criteria) and information corresponding to the desired date and or times for the appointment (calendar criteria). In certain embodiments the agent may prompt a user for additional information, such as insurance criteria, patient satisfaction criteria and patient retention criteria, for example.

At step 520 the agent searches one or more healthcare provider systems for available appointments based on the search criteria. For example, the agent may search through all healthcare provider systems on the network to determine which healthcare providers offer available appointments that meet all, or some of the user's search criteria.

At step 530 the agent generates an array of available appointments based on the search from step 520. In certain embodiments, the agent may identify an anticipated length of appointment time based on the search criteria and only elect from available appointment times long enough to satisfy the time for the particular appointment. For example, where a user states that the purpose of the visit is for a general check-up, and the anticipated general check-up appointment time is one hour, the agent may not include appointments that are only available for 30 minutes in the array. In certain embodiments, the array may include every appointment identified in the search of step 520. In certain embodiments, the array may include only those appointments that meet every one of the user's search criteria. Alternatively, the agent may generate an array of a predetermined number of appointments that best meet the search criteria. For example, the agent may generate an array of the 20 appointments that most closely meet the user's search criteria.

At step 540 the array of available appointments is populated on a user interface. A user may elect to sort the appointments in the array based upon certain criteria. For example, a user may elect to view the appointments of the array in order of the provider's distance from the user's home. The user may also elect to sort the array based on multiple criteria.

At step 550, a user is prompted to select an available appointment from the array. A user may elect one or more appointments from the array displayed on the interface, or the user may elect to conduct another search based on new criteria. In certain embodiments, the user may be prompted to confirm the appointment selection to prevent scheduling of unwanted appointment times. In certain embodiments, a user may elect to obtain more information about a provider from the interface. For example, the user interface may provide hyperlinks to the providers website, or another website with provider information.

At step 560 the agent schedules an appointment with the provider in response to user instruction. In certain embodiments, the agent may update the healthcare provider's status from available to unavailable based on the scheduling of the appointment. For example, where a first user schedules an appointment with a provider and second user later conducts a search via the agent with the same criteria, the appointment time scheduled for the first user will not appear as available on the second user's search. In certain embodiments the user may send a confirmation message to either or both the user and the provider notifying of the appointment.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments provide a technical effect of providing systems, methods and interfaces for providing a user with healthcare visit options based upon information entered by a user and scheduling of an appointment based on available options. Certain embodiments provide a variety of options and search criteria to determine available appointments and facilitate scheduling.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

Those skilled in the art will appreciate that the embodiments disclosed herein may be applied to the formation of any clinical system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for scheduling a patient appointment to visit a healthcare provider via a user interface comprising:
prompting a user for at least one appointment criterion via said user interface;
searching at least one healthcare provider system for available appointments based on said at least one appointment criterion;
generating an array of available healthcare provider appointments based on the results of said search of at least one healthcare provider system; and
populating said interface with said array of available healthcare provider appointments, each of said healthcare provider appointment corresponding to a healthcare provider.

2. The method of claim 1, further comprising prompting a user to select from said array of available healthcare provider appointments and reserving an appointment on a healthcare provider system based on said selection.

3. The method of claim 1, wherein said prompting for at least one appointment criterion step comprises at least one of prompting for one or more visit basis criteria, prompting for one or more location criteria and prompting for one or more visit calendar criteria.

4. The method of claim 2, further comprising prompting a user for at least one insurance criterion, wherein said array of healthcare providers is generated based further on said at least one insurance criterion.

5. The method of claim 1, further comprising prompting a user for at least one provider satisfaction criterion, wherein said array of healthcare providers is generated based further on said at least one provider satisfaction criterion.

6. The method of claim 1, further comprising prompting a user for a patient retention rate, wherein said array of healthcare providers is generated based further on said patient retention rate.

7. The method of claim 1, further comprising providing a filter to sort said array of healthcare providers based on at least one filter criterion, wherein said user selects at least one of said filter criterion from a list of filter options.

8. The method of claim 7, wherein said list of filter options comprises at least one of appointment times, distance away from patient, cost of visit, appointment cost, provider insurance information, patient satisfaction with provider and patient retention rate of provider.

9. The method of claim 1 further comprising crawling one or more databases associated with one or more healthcare providers to generate said array of healthcare providers.

10. The method of claim 9 wherein said databases are accessible to said interface via a network.

11. The method of claim 10 wherein said databases are accessible to said interface via the internet.

12. A healthcare visit agent for searching for and scheduling healthcare provider appointments for a user, said agent comprising:
a user interface allowing the user to interact with the agent via a network;
a healthcare network server connecting said agent with one or more healthcare provider systems;
an appointment search engine in communication with said user interface and said healthcare network server; and
an appointment scheduler in communication with said user interface and said healthcare network server,
wherein said user interface prompts a user for at least one search criterion, said appointment search engine searches for available healthcare provider appointments on said one or more healthcare provider systems via said healthcare network server based on said at least one search criterion, said appointment search engine populates the search results on said user interface, and said appointment scheduler reserves appointments on said one or more healthcare systems upon receiving appointment instructions from a user via the user interface.

13. The healthcare visit agent of claim 12, further comprising a sorting engine for sorting said search results based on user selected sorting criteria.

14. The healthcare visit agent of claim 12, wherein said search criteria includes at least one of a visit basis criteria, location criteria and calendar criteria.

15. The healthcare visit agent of claim 14, wherein said search criteria includes each of visit basis criteria, location criteria and calendar criteria.

16. The healthcare visit agent of claim 14, wherein said search criteria also comprises at least one of insurance criteria, patient satisfaction criteria and patient retention criteria.

17. The healthcare visit agent of claim 12, wherein said user interface is a web page accessible on the Internet.

18. The healthcare visit agent of claim 12, further comprising an account manager receiving and storing user preferences, and accessing said user preferences upon log in by said user.

19. The healthcare visit agent of claim 12, further comprising an appointment time estimation tool, wherein said appointment time estimation tool produces an estimated length of appointment based on said search criteria.

20. A computer readable medium and logic for instruction execution, said computer readable medium encoded with instructions for execution in a computer system, said instructions, when executed on a computer system
provide access to a user interface via a computer workstation;
offer at least one healthcare provider appointment search criterion for user selection;
instruct a search engine, upon command by a user, to conduct a search on at least one healthcare provider system for available healthcare provider appointments based on said at least one healthcare provider appointment search criterion;
offer at least one healthcare provider appointment to a user for user selection; and
instruct a scheduler, upon user selection of at least one healthcare provider appointment, to reserve said at least one healthcare provider appointment with the healthcare provider system.
